(19) United States
(12) Patent Application Publication
(10) Pub. No.: US 2012/0050497 A1
(43) Pub. Date: Mar. 1, 2012

(54) APPARATUS, METHOD AND COMPUTER READABLE MEDIUM FOR SHADING CORRECTION, AND IMAGING APPARATUS

(75) Inventor: Fumitaka SUTO, Tokyo (JP)

(73) Assignee: HOYA CORPORATION, Tokyo (JP)

(21) Appl. No.: 13/220,007

(22) Filed: Aug. 29, 2011

(30) Foreign Application Priority Data
Aug. 30, 2010 (JP) 2010-191699

(51) Int. Cl. G06K 9/40; H04N 13/02

(52) U.S. Cl. 348/49; 382/274; 348/E13.074

(57) ABSTRACT

A shading correction apparatus, which includes a reception unit which receives left and right parallax images shot through a single imaging optical system, and a shading correction unit configured to execute different types of shading corrections respectively for the left and right parallax images so as to reduce a difference in illuminance between the left and right parallax images.

### BACKGROUND OF THE INVENTION

The present invention relates to an apparatus, a method and a computer readable medium for shading correction, and an imaging apparatus which are configured to execute shading correction for stereoscopic images.

In general, when a person alternately views images having parallax through the person's respective left and right eye, the person recognizes the images as a three dimensional object. There are apparatuses known as stereographic imaging apparatuses which are configured to cause a person to recognize a two-dimensional image as a three-dimensional image through use of the above described physiological phenomenon. Each of Japanese Patent Provisional Publications No. HEI 10-271534A (hereafter, referred to as patent document #1), No. 2002-6425A (hereafter, referred to as patent document #2) and No. HEI 08-15616A (hereafter, referred to as patent document #3) discloses a detailed configuration of a stereographic imaging apparatus of the above described type.

The stereographic imaging apparatus described in each of patent documents #1 to #3 is configured to shoot a three-dimensional image through a single imaging optical system. More specifically, the stereographic imaging apparatus described in each of patent documents #1 and #2 has a pair of left and right shutters respectively located at left and right positions at a certain interval with respect to an optical axis of the imaging optical system centered therebetween. The pair of left and right shutters alternately open or close in a time-sharing manner in synchronization with a frame rate of an imaging device. When scattered light from an object passes through an aperture of a shutter and converges onto an imaging surface of the imaging device, parallax images which are shifted with respect to each other in the left and right direction are alternately obtained. The stereographic imaging apparatus described in patent document #3 includes a relay lens system, a pupil formation lens system and a pair of left and right mirrors (a prism whose vertex is located on an optical axis), which are arranged in this order on the rear side of an objective lens system. In this configuration, the pair of left and right mirrors are arranged to face different directions with respect to the optical axis. Scattered light from an object passes through a single optical system including the objective lens system, the relay lens system and the pupil formation lens system, and is divided, by reflection from mirror surfaces of the prism, into light beams proceeding in different directions, and then the divided light beams are converged simultaneously on imaging surfaces of a pair of left and right imaging devices, respectively. As a result, parallax images which are shifted with respect to each other in the left and right direction can be simultaneously obtained.

### SUMMARY OF THE INVENTION

Each of FIGS. 1A and 1B generally illustrates a pupil dividing liquid crystal shutter DS provided in the stereographic imaging apparatus of the shooting type described in each of patent documents #1 and #2. Each of FIGS. 1A and 1B is an illustration of the pupil dividing liquid crystal shutter DS viewed from the object side along an optical axis of the imaging optical system. As shown in FIG. 1A, the pupil dividing liquid crystal shutter DS has a liquid crystal shutter S1 for a left eye and a liquid crystal shutter S2 for a right eye. Apertures for the left and right liquid crystal shutters S1 and S2 are designed to have the same shape and the same size. As described above, the stereographic imaging apparatus of the above described type has a common imaging optical system for the left and right shutters. Therefore, it is generally believed that the light exposures are the same between the left and right images, and also the illuminance distributions are the same between the left and right images. Regarding the illuminance distribution, it is considered that, according to optical vignetting and cosine fourth law, the peripheral brightness is uniformly lowered throughout the entire circumferential region in each image. However, such illuminance distribution has not been discussed in detailed. As explained below, the inventor of the present invention has found that the illuminance distribution is not the same between the left and right images. As used herein, the term “illuminance distribution” means distribution of illuminance obtained when an object having a uniform brightness over the whole imaging area is shot.

FIGS. 2A, 2B, 3A and 3B are explanatory illustrations for explaining a main factor of the above described phenomenon where illuminance distributions are different between left and right images in the stereographic imaging apparatus of the shooting type described in patent documents #1 and #2. Specifically, FIGS. 2A and 2B illustrate the illuminance distribution of an object image which has passed through the shutter S1 for the left eye, and FIGS. 3A and 3B illustrate the illuminance distribution of an object image which has passed through the shutter S2 for the right eye. Each of FIGS. 2A and 3A is a three dimensional graph of the illuminance distribution on the imaging surface of the imaging device. Each of FIGS. 2B and 3B is a two dimensional graph of the illuminance distribution on the imaging surface of the imaging device. In each of FIGS. 2A, 2B, 3A and 3B, a position on the imaging surface is defined by an XY coordinate. Z axis in FIGS. 2A and 3A represents the illuminance value. In each of FIGS. 2B and 3B, the illuminance values are represented by contour lines.

FIG. 1B illustrates a relationship between an off-axis light beam BM incident on an apex P1 and the shutter apertures. A part of the off-axis light beam BM is blocked by components, such as a rim or a holding frame of a lens located before or after the shutters. In this case, a cross section of the off-axis light beam BM on the shutter surface has a shape formed such that a perfect circle is cut by arcs. When the shutter S1 for the left eye is opened, a light beam of a hatched area R1 of the off-axis light beam BM passes through the shutter S1 for the left eye, and is incident on the apex P1. When the shutter S2 for the right eye is opened, a light beam of a hatched area R2 of the off-axis light beam BM passes through the shutter S2 for the right eye, and is incident on the apex P1.

The hatched area R1 is smaller than the hatched area R2. Therefore, the light amount of the off-axis light beam BM incident on the apex P1 when the shutter S1 for the left eye is in the opened state is smaller than the light amount of the off-axis light beam BM incident on the apex P1 when the shutter S2 for the right eye is in the opened state. As can be seen from the comparison between FIG. 2A and FIG. 3A (or FIG. 2B and FIG. 3B), it is understood that the apex P1 in the left image is darker than the apex P1 in the right image. As described above, the effects on the off-axis light beam BM by optical vignetting are different between the left and right images. For this reason, as shown in FIGS. 2A, 2B, 3A and 3B, the illuminance distribution of the left image and the illuminance distribution of the right image are not equal to each other. Since the difference in illuminance between the parallax images may give uncomfortable feeling to an observer and may hamper the normal stereoscopic viewing. Therefore, it is desired to solve the above described problem.

For example, in a central portion of a surface of a variable aperture in an imaging optical system, even the off-axis light having a larger angle of view is not affected by a lens or restriction by a fixed aperture. As a concrete example of a configuration for reducing the difference in illuminance between the parallax images, one might consider a configuration where each of apertures of the shutters S1 and S2 is reduced to the extent that effect by aperture restriction can be neglected and the shutters S1 and S2 are located closely with respect to each other. However, in compensation for decreasing the interval between chief rays of the left and right apertures, appearance of solidity of the images is impaired. Furthermore, in order to compensate for lack of the light amount due to decrease of the aperture of the shutter, it becomes necessary to increase the exposure time. In this case, camera shake may become easy to occur and the chronophotographic shooting becomes difficult. Furthermore, since the depth of field is increased due to decrease of the aperture of the shutter, shooting utilizing effect of bokeh becomes difficult.

FIGS. 8A and 8B generally illustrate a pupil plane in the stereographic imaging apparatus described in patent document #3. The pupil plane shown in FIGS. 8A and 8B is viewed from the object side along the optical axis AX. Specifically, FIG. 8A shows the on-axis light beam BM' on the pupil plane, and FIG. 8B shows the off-axis light beam BM on the pupil plane. The term pupil plane is defined as a plane with which the optical axis AX intersects perpendicularly and which passes through the vertex of a prism. In each of FIGS. 8A and 8B, the right half part corresponds to a mirror surface which directs an incident light beam to a right side imaging device, and the left half part corresponds to a minor surface which directs the incident light beam to a left side imaging device. As in the case of patent documents #1 and #2, the effects of optical vignetting on the off-axis light beam BM are different between the left and right images in patent document #3 as shown in FIG. 8B. Therefore, the illuminance distributions of the images for the left and right eyes are not equal to each other (see areas R1 and R2 in FIG. 8B).

As another example of a configuration for reducing the difference in illuminance between parallax images, one might consider employing an optical system configured not to be affected by a lens or the aperture restriction by a fixed aperture. However, in this case, it becomes necessary to increase the size of a lens. Therefore, the weight of the apparatus increases and thereby usability of the apparatus is impaired. Furthermore, in this case, the manufacturing cost increases. Therefore, the above described configuration can not be employed without careful consideration.

The present invention is advantageous in that it provides an apparatus, a method and a computer readable medium, and an imaging apparatus for shading correction which are configured to suitably reduce the difference in illuminance between left and right images having parallax.

According to an aspect of the invention, there is provided a shading correction apparatus, which includes a reception unit which receives left and right parallax images shot through a single imaging optical system, and a shading correction unit configured to execute different types of shading corrections respectively for the left and right parallax images so as to reduce a difference in illuminance between the left and right parallax images.

By thus executing the different types of shading corrections respectively for the left and right parallax images, it becomes possible to suitably reduce the difference in illuminance between the parallax images without employing the configuration where the aperture size of each of the left and right shutters is decreased or the large lens is used.

In at least one aspect, the shading correction unit may respectively multiply output values of pixels of the left and right parallax images by correction coefficients of the two different types of distributions.

In at least one aspect, the two different types of distributions for the correction coefficients respectively corresponding to the left and right parallax images may be defined such that correction coefficients of each of the left and right parallax images are arranged in accordance with a pixel arrangement of each of the left and right parallax images. In this case, the two different types of distributions for the correction coefficient for the left and right parallax images have, for example, an inverted relationship with respect to a line segment which divides each of the left and right parallax images into two equal parts.

In at least one aspect, the shading correction apparatus may further include a coefficient holding unit configured to hold the correction coefficients corresponding to a type of the imaging optical system or zooming positions of the imaging optical system, a recognition unit configured to recognize the type of the imaging optical system or the zooming positions of the imaging optical system, and a coefficient selection unit configured to select the correction coefficients from the coefficient holding unit in accordance with a result of recognition by the recognition unit. In this configuration, the shading correction unit executes a shading correction using the selected correction coefficients by the coefficient selection unit.

According to another aspect of the invention, there is provided a method for shading correction, which includes receiving left and right parallax images shot through a single imaging optical system, and executing different types of shading corrections respectively for the left and right parallax images so as to reduce a difference in illuminance between the left and right parallax images.

By thus executing the different types of shading corrections respectively for the left and right parallax images, it becomes possible to suitably reduce the difference in illuminance between the parallax images without employing the configuration where the aperture size of each of the left and right shutters is decreased or the large lens is used.

In at least one aspect, in the step of executing the different types of shading corrections, output values of pixels of the left and right parallax images may be multiplied respectively by correction coefficients of two different types of distributions.

In at least one aspect, the two different types of distributions for the correction coefficients corresponding to the left and right parallax images are defined such that correction coefficients of each of the left and right parallax images may be arranged in accordance with a pixel arrangement of each of the left and right parallax images. In this case, the two different types of distributions for the correction coefficient for the left and right parallax images have an inverted relationship with respect to a line segment which divides each of the left and right parallax images into two equal parts.

In at least one aspect, the method may further include recognizing a type of the imaging optical system or a zooming position of the imaging optical system, and selecting correction coefficients corresponding to a recognized type of the imaging optical system or a recognized zooming position of the imaging optical system, from correction coefficients stored in a coefficient holding unit. In this case, in the executing step, a shading correction is executed using the selected correction coefficients.

According to another aspect of the invention, there is provided a non-transitory computer readable medium having computer readable instruction stored thereon, which, when executed by a processor of a computer, configures the processor to perform the steps of the above described method.

According to another aspect of the invention, there is provided an imaging apparatus, which includes a pair of left and right shutters arranged to have a certain interval therebetween to sandwich an optical axis in an imaging optical system, an open and close driving unit configured to open or close the pair of left and right shutters at a predetermined rate, an imaging device which is driven in synchronization with the predetermined rate and on which an object image passed through each of the pair of left and right shutters is converged, a shading correction unit configured to execute different types of shading corrections respectively for images shot through the pair of left and right shutters so as to reduce a difference in illuminance between the images. The shading correction unit may be configured as one of the above described shading correction apparatus.

### BRIEF DESCRIPTION OF THE ACCOMPANYING DRAWINGS

FIGS. 1A and 1B generally illustrate a conventional shutter arranged in a stereographic imaging apparatus.

FIGS. 2A and 2B are graphs for explaining a main factor of a phenomenon where illuminance distributions are different between left and right images.

FIGS. 3A and 3B are graphs for explaining a main factor of a phenomenon where illuminance distributions are different between left and right images.

FIG. 4 illustrates a configuration of an imaging apparatus having a shading correction apparatus according to an embodiment of the invention.

FIG. 5 is a lens layout diagram illustrating a configuration of an imaging optical system according to the embodiment of the invention.

FIGS. 6A and 6B show a distribution graph of a correction gain computing coefficient F for an image of a left eye.

FIGS. 7A and 7B show an illuminance distribution graph of an image for a left eye after execution of a shading correction.

FIGS. 8A and 8B generally illustrate a pupil division mirror (prism) arranged in a conventional stereographic imaging apparatus.

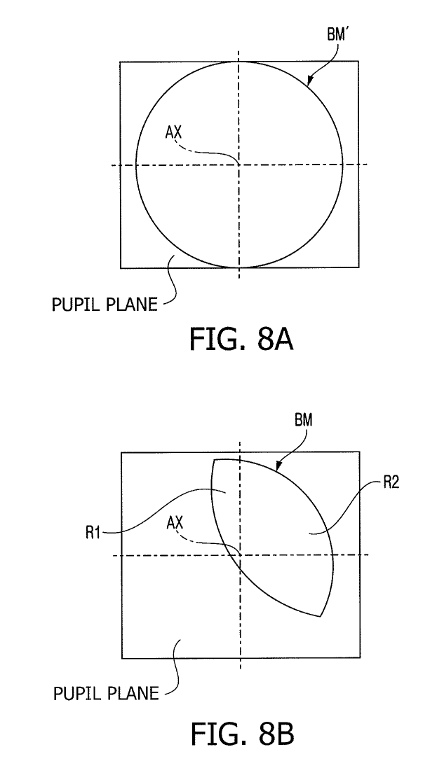

### DETAILED DESCRIPTION OF THE EMBODIMENTS

Hereinafter, an embodiment according to the invention is described with reference to the accompanying drawings. It is noted that various connections are set forth between elements in the following description. It is noted that these connections in general and unless specified otherwise, may be direct or indirect and that this specification is not intended to be limiting in this respect. Aspects of the invention may be implemented in computer software as programs storable on computer-readable media including but not limited to RAMs, ROMs, flash memory, EEPROMs, CD-media, DVD-media, temporary storage, hard disk drives, floppy drives, permanent storage, and the like.

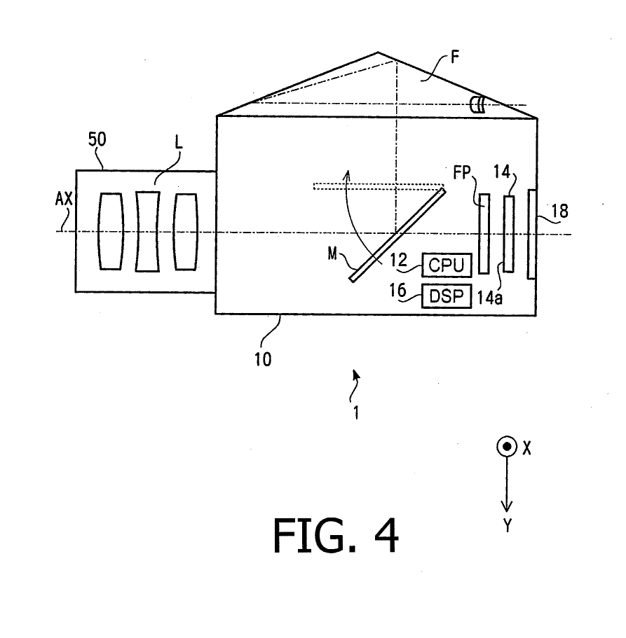

FIG. 4 illustrates a configuration of an imaging apparatus 1 having a shading correction apparatus according to the embodiment of the invention. In this embodiment, the imaging apparatus is formed as a single lens reflex digital camera. However, in another embodiment, the imaging apparatus 1 may be formed as another type of apparatus having an imaging function, such as a compact digital camera, an endoscope, a fundus camera, a camcorder, a mobile phone, a PHS (Personal Handy Phone) or a portable game machine.

As shown in FIG. 4, the imaging apparatus 1 includes a camera main body 10 and a shooting lens 50. The camera main body 10 includes a CPU 12 which totally controls operations and timing of various components in the camera main body 10. Scattering light from an object is incident on a finder optical system F via an imaging optical system L and a mirror M. A photographer is able to observe an object image by peeking into an eyepiece of the finder optical system F. It should be noted that in FIG. 4 connections between various electronic components are omitted for the sake of simplicity.

When a release switch is pressed, the mirror M shown in FIG. 4 is lifted up to a position indicated by a dashed line, and a focal plane shutter FP is opened for a time corresponding to the shutter speed. As a result, the scattering light from the object is received by a solid-state imaging device 14 after passing through the imaging optical system L and the focal plane shutter FP.

The solid-state imaging device 14 is a single-chip color CCD (Charge Coupled Device) image sensor having a bayer layout. The solid-state imaging device 14 accumulates, at each pixel, charges responsive to a light amount of an optical image formed on an imaging surface 14a, and converts the charges into an image signal. The image signal is subjected to A-D conversion and the signal amplification by circuits (not shown), and is inputted to a DSP (Digital Signal Processor) 16. It should be noted that the solid-state imaging device 14 is not limited to a CCD image sensor, but may be a CMOS (Complementary Metal Oxide Semiconductor) image sensor. In the following, directions which are perpendicularly intersect with the direction of the optical axis AX of the imaging optical system L and are perpendicularly intersect with respect to each other are defined as X axis direction and Y axis direction, respectively. The X axis direction and the Y axis direction respectively correspond to the horizontal direction and the vertical direction of the imaging surface 4a.

The DSP 16 executes varies types of signal processing, such as color interpolation, a matrix operation and Y/C separation, for the inputted image signal, generates a luminance signal Y and chrominance difference signals Cb and Cr, and compresses the image signal in a certain format such as JPEG (Joint Photographic Experts Group). The compressed image signal (i.e., image data) is then stored in a memory card inserted into a card slot of the camera main body 10. The DSP 16 buffers the respective color signals after the matrix operation into separate memories in frame. The DSP 16 reads out each color signal buffered in each memory at predetermined timing, converts the color signal into an image signal to generate an image, and displays the image on a LCD (Liquid Crystal Display) monitor 18. Thus, the photographer is able to view the image through the LCD monitor 18.

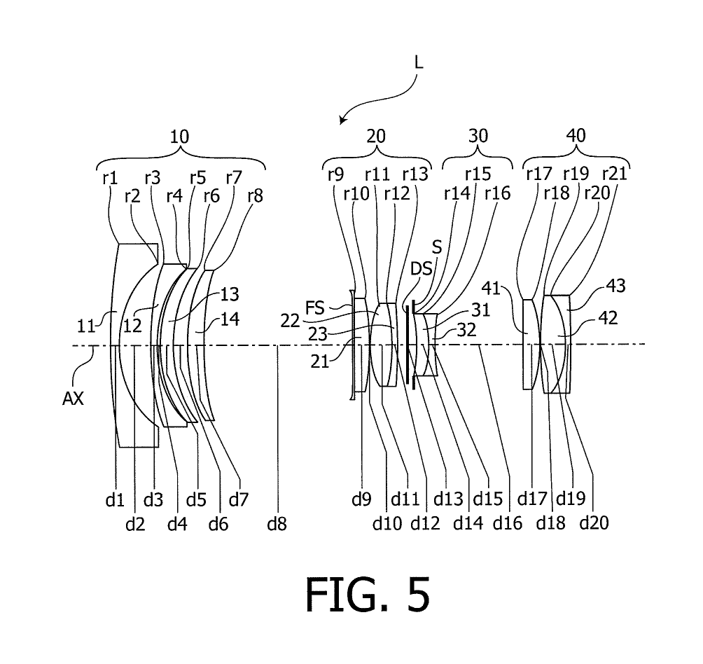

FIG. 5 is a lens layout diagram illustrating a configuration of the imaging optical system L. The imaging optical system L includes a negative first lens group 10, a positive second lens group 20, a negative third lens group 30 and a positive fourth lens group 40, which are arranged in this order from the object side. The first lens group 10 includes a negative meniscus lens 11, a negative meniscus lens 12, a negative meniscus lens 13, and a positive meniscus lens 14 which are arranged in this order from the object side and each of which has a convex surface on the object side. The second lens group 20 includes a biconvex positive lens 21 and a cemented lens arranged in this order from the object side, and the cemented lens of the second lens group 20 is formed by bonding a biconvex positive lens 22 and a negative meniscus lens 23. The third lens group 30 includes a cemented lens in which a positive meniscus lens 31 having a convex surface on the image side and a biconcave negative lens 32 arranged in this order from the object side are bonded together. The fourth lens group 40 includes a biconvex positive lens 41 and a cemented lens arranged in this order from the object side, and the cemented lens of the fourth lens group is formed by boding a biconvex positive lens 42 and a negative meniscus lens 43 having a convex surface on the image side. At a position shifted 0.3 mm frontward from a pole of the ninth surface (the second lens group 20), a fixed aperture FS having a fixed diameter is arranged. At a position shifted 0.36 mm frontward from a pole of the fourteenth surface (the third lens group 30), a variable aperture S having a changeable diameter is arranged. At a position close to the variable aperture S, the pupil dividing liquid crystal shutter DS is arranged.

Table 1 indicated below shows a concrete numeric configuration of the imaging optical system L. In Table 1, F_{NO}. denotes F-number, f represents a focal length of the total system (unit: mm), W denotes a half angle of view (unit: degree) and fB denotes a back focus (unit: mm). In Table 1, “r” denotes the curvature radius (unit: mm) of each optical surface, “d” denotes the thickness of an optical component or the distance (unit: mm) from each optical surface to the next optical surface, “Nd” denotes the refractive index at a d-line, and ν denotes Abbe's number at a d-line. Values which change during zooming operation are represented in the order of the value at the short focal length edge and the value at the long focal length edge (e.g., d: 26.08-3.00 of Surface No. 8).

The sixth surface (the first lens group 10) is a rotationally symmetrical aspherical surface. A shape of a rotationally symmetrical aspherical surface is expressed by a following equation:

x=cy²/[1+[1−(1+K)c²y²]^{1/2}]+A4y⁴+A6y⁶+A8y⁸+A10y¹⁰+A12y¹²+ . . . .

where c denotes a curvature (1/r) of the aspherical surface, y denotes a height from the optical axis, κ is Conic constant, and A₄, A₆, . . . represent aspheric coefficients larger than or equal to the fourth order. In this case, “r” denotes the curvature radius (i.e., the paraxial curvature radius) on the optical axis.

TABLE 1
F_{No}. = 1:3.5-5.7
f = 19.10-55.16
W = 37.9-14.3
12 fB = 37.71-58.13

| Surface No. | r | d | Nd | ν |
|---|---|---|---|---|
| 1 | 106.359 | 1.30 | 1.60311 | 60.7 |
| 2 | 18.599 | 5.46 | — | — |
| 3 | 46.313 | 1.20 | 1.62299 | 58.2 |
| 4 | 20.485 | 0.55 | — | — |
| 5 | 21.692 | 2.20 | 1.52538 | 56.3 |
| 6* | 19.048 | 2.60 | — | — |
| 7 | 30.674 | 2.75 | 1.84666 | 23.8 |
| 8 | 49.739 | 26.08-3.00 | — | — |
| 9 | 86.921 | 3.01 | 1.51601 | 49.9 |
| 10 | −36.585 | 0.20 | — | — |
| 11 | 19.624 | 3.72 | 1.48749 | 70.2 |
| 12 | −32.878 | 1.00 | 1.84333 | 24.2 |
| 13 | −176.955 | 3.36-16.26 | — | — |
| 14 | −42.791 | 2.13 | 1.84700 | 24.0 |
| 15 | −16.494 | 1.00 | 1.77249 | 49.4 |
| 16 | 37.235 | 15.40-2.50 | — | — |
| 17 | 268.822 | 3.03 | 1.64118 | 58.9 |
| 18 | −23.286 | 0.10 | — | — |
| 19 | 59.669 | 4.46 | 1.51601 | 50.6 |
| 20 | −16.653 | 1.00 | 1.75589 | 28.8 |
| 21 | −129.497 | — | — | — |

Aspherical Surface Data

| Surface No. | 6 |
|---|---|
| κ | 0.00000 |
| A4 | −0.32236 × 10⁻⁴ |
| A6 | −0.71389 × 10⁻⁷ |
| A8 | 0.88889 × 10⁻¹⁰ |
| A10 | −0.72416 × 10⁻¹² |

*rotationally symmetrical aspherical surface
Aspheric coefficients not shown are all 0.00.

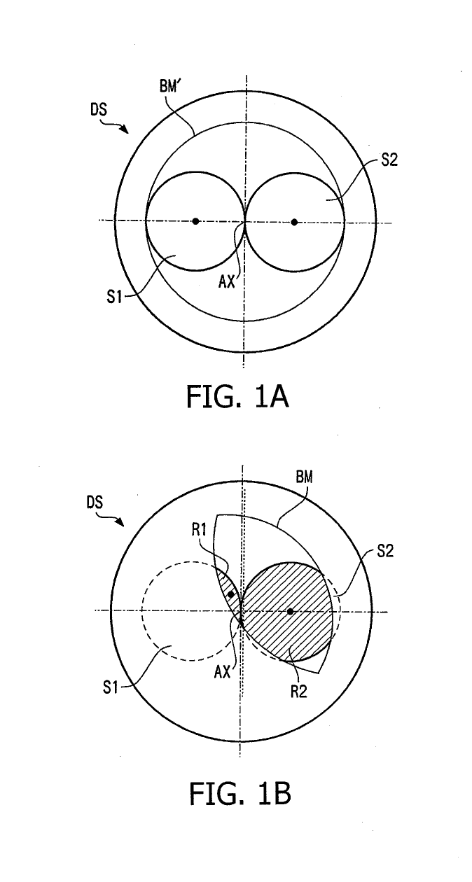

The pupil dividing liquid crystal shutter DS may be a liquid crystal shutter having a know structure, and has a structure substantially the same as that of the shutter shown in FIG. 1. That is, the pupil dividing liquid crystal shutter DS has a pair of left and right shutters (the shutter S1 for the left eye and the shutter S2 for the right eye) arranged to have a predetermined interval such that the optical axis AX is positioned at the center between the left and right shutters S1 and S2. The shutter S1 for the left eye and the shutter S2 for the right eye have the same shape and the same size. The shutter S1 for the left eye and the shutter S2 for the right eye alternately open or close in a time-sharing manner in synchronization with a frame rate of the solid state imaging device 14. Since the pupil dividing liquid crystal shutter DS is shown in FIGS. 1A and 1B, the structure of the pupil dividing liquid crystal shutter DS is explained with reference to FIGS. 1A and 1B.

As shown in FIG. 1A, a cross section of an on-axis light beam BM' on a surface of the pupil dividing liquid crystal shutter DS has a circular shape uniformly covering the both apertures of the shutters S1 an S2 for the left and right eyes. Therefore, regarding the on-axis light beam BM', the amount of light passing through the shutter S1 and the amount of light passing through the shutter S2 are equal to each other. Regarding the on-axis light beam BM', the illuminance on the imaging surface 14a for the shutter S1 is equal to the illuminance on the imaging surface 14a for the shutter S2. By contrast, regarding the off-axis light beam BM, the amount of light passing through the shutter S1 and the amount of light passing through the shutter S2 are different from each other as shown FIG. 1B. Therefore, as described above, the illuminance on the imaging surface 14a for the left eye is not equal to the illuminance on the imaging surface 14a for the right eye.

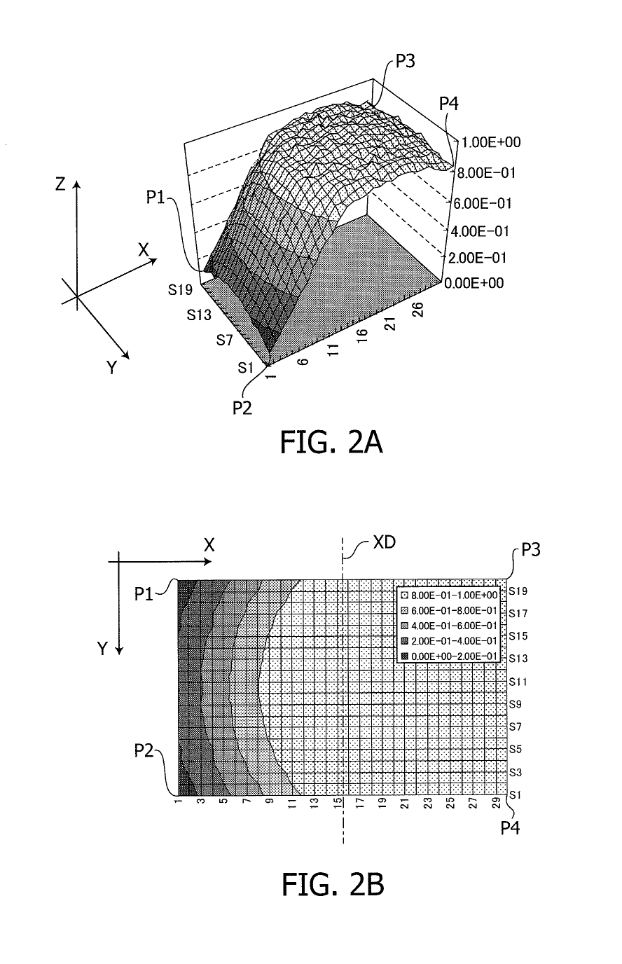

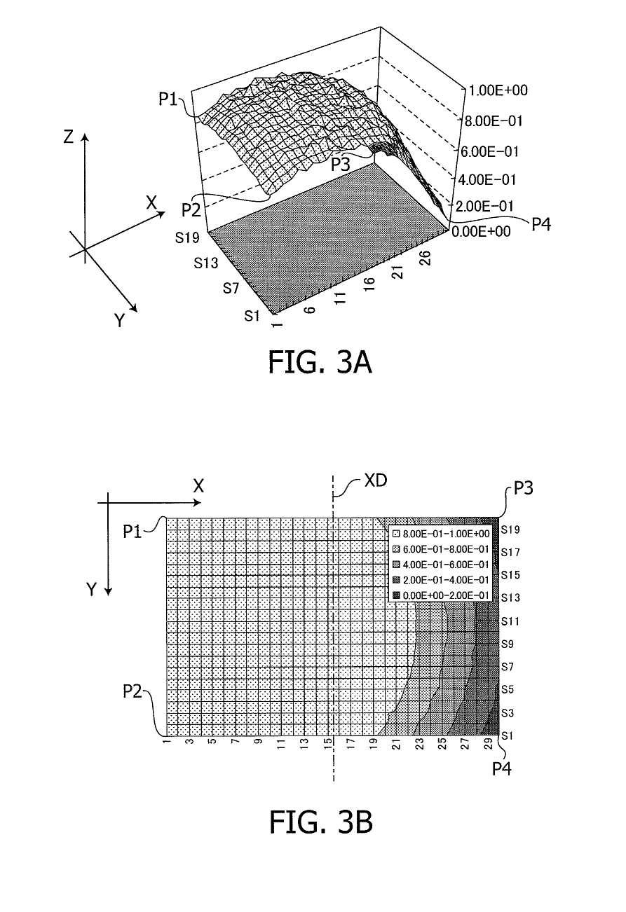

The illuminance distributions of the images for the left and right eyes on the imaging surface 14a will now be explained with reference to FIGS. 2 and 3. The imaging surface 14a has a rectangular shape defined by the apexes P1 to P4. A point on the imaging surface 14a is represented by a XY coordinate having an origin equal to a center of the imaging surface 14a. The coordinates of the apexes P1 to P4 are (−7.9 mm, −11.85 mm), (−7.9 mm, 11.85 mm), (7.9 mm, −11.85 mm), (7.9 mm, 11.85 mm), respectively. A line segment XD indicated in FIGS. 2B and 3B is a line passing through the origin of the coordinate system along the Y direction, and divides the imaging surface 14a into two equal parts.

As shown in FIGS. 2A, 2B, 3A and 3B, the illuminance distributions of the images for the left and right eyes are different from each other. Specifically, the images for the left and right eyes have the illuminance distributions having the inverted relationship with respect to the line segment XD. In order to allow an observer to suitably conduct stereoscopic viewing, it is necessary to reduce the difference in illuminance between the parallax images. For this reason, in this embodiment, a shading correction function is embedded in the DSP 16. That is, the DSP 16 functions as a shading correction apparatus.

In the imaging optical system L according to the embodiment, illuminance reduction by optical vignetting is dominative with respect to the illuminance reduction by cosine fourth law. Therefore, in the following, explanation about the illuminance reduction by cosine fourth law is omitted for the sake of simplicity. However, it should be noted that, depending on specifications of the imaging optical system L, there is a case where the illuminance reduction by cosine fourth law becomes dominant. Even in such a case, the illuminance distributions of the images for the left and right eyes do not become equal to each other.

The DSP 16 has a correction gain computing coefficient F. The DSP 16 obtains a luminance signal O by multiplying the luminance signal Y of each coordinate (i.e., each pixel) of each of the images for the left and right eyes produced through Y/C separation by the correction gain computing coefficient F as shown in the following expression (1):

O∝F·Y (1)

The correction gain computing coefficient F is defined by a following expression (2).

$$F = {\sum }_{i = 0}^{9} ( {a}_{i} {r}^{i} ) + {F}_{0} \\ where \\ r = \sqrt{{( x - {x}_{0} )}^{2} + {y}^{2}} \qquad ( 2 )$$

Concrete numeric examples of coefficient ai, constant F₀ of the expression (2) are shown in Table 2.

TABLE 2

| F₀ | a0 | a1 | a2 | a3 | a4 |
|---|---|---|---|---|---|
| 1.000E+00 | 4.205E+00 | −5.077E−02 | 6.883E−03 | 1.934E−03 | −2.035E−04 |

| a5 | a6 | a7 | a8 | a9 |
|---|---|---|---|---|
| −2.586-05 | −2.495E−06 | 1.333E−06 | −1.094E−07 | 2.752E−09 |

The parameter for correcting the luminance signal Y of the image for the left eye is x₀=4.2 mm. The parameter for correcting the luminance signal Y of the image for the right eye is x₀=−4.2 mm. In other words, the parameters x₀ for the left and right images have the inverted positional relationship with respect to the line segment XD. As described above, the DSP 16 executes the shading correction separately for the left and right images which are alternately shot. By monitoring signals from the CPU 12, the DSP 16 is able to know whether a signal to be subjected to the shading correction is for the left image or for the right image.

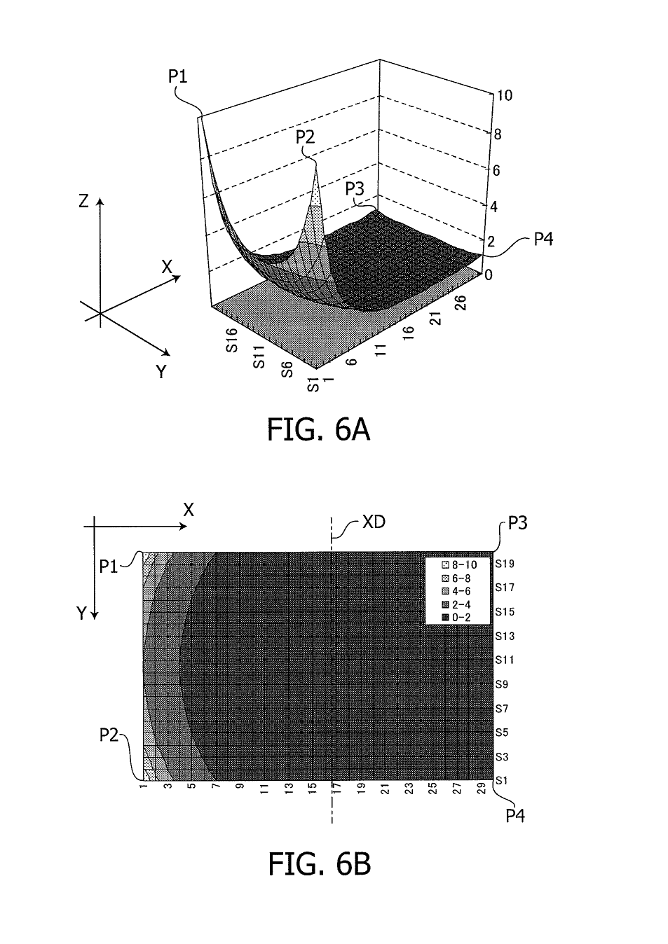

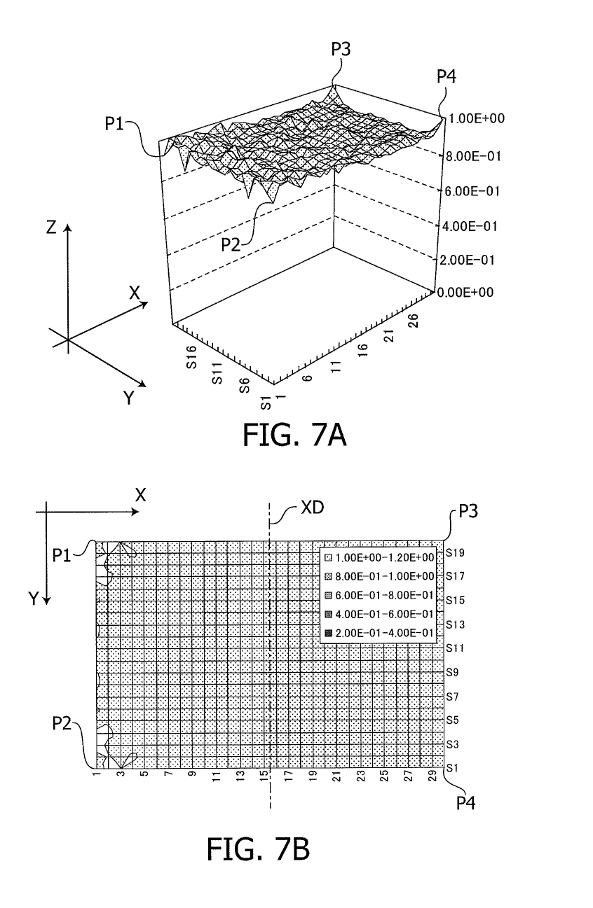

FIGS. 6A and 6B show a distribution graph of the correction gain computing coefficient F for the image of the left eye calculated by the expression (2). FIGS. 6A and 6B respectively correspond to FIGS. 2A and 2B. That is, FIG. 6A is the three dimensional graph of the correction gain computing coefficient F, and FIG. 6B is the two dimensional graph of the correction gain computing coefficient F. FIG. 7A shows a result of calculation obtained by multiplying the illuminance distribution in FIG. 2A and the distribution of the correction gain computing coefficient F in FIG. 6A together. FIG. 7B shows a result of calculation obtained by multiplying the illuminance distribution in FIG. 2B and the distribution of the correction gain computing coefficient F in FIG. 6B together. That is, FIGS. 7A and 7B shows a distribution of the output value of the luminance signal O. As shown in FIGS. 7A and 7B, thanks to the shading correction using the correction gain computing coefficient F, the image for the left eye has a uniform illuminance distribution.

The DSP 16 also executes the shading correction using the expression (1) for the image of the right eye which is generated in a next frame. However, it is impossible to uniform the illuminance distribution of the image for the right eye if the same shading correction as that used for the previous frame is used. For this reason, according to the embodiment, the value of the parameter x₀ is changed to −4.2 for the shading correction for the image for the right eye. The correction gain computing coefficient F for the right eye has the distribution obtained by inverting the distribution of the correction gain computing coefficient F for the left eye with respect to the line segment XD. By multiplying the luminance signal Y by the correction gain computing coefficient F for the image for the right eye, the illuminance distribution which is uniform and has the same level as that for the image for the left eye can be obtained. That is, the image for the left eye and the image for the right eye have the same illuminance distribution.

As described above, according to the embodiment, it is possible to reduce the difference in illuminance between the parallax images without reducing the aperture of each of the shutters S1 and S2 for the left and right eyes. In addition, there is no necessity to increase the effective light beam diameter of the imaging optical system L for reducing the difference in illuminance between the parallax images.

As described above, the inventor of the present invention thinks up the embodiment where the different types of shading corrections are applied to the left and right images without being obsessed by common technical knowledge in the art where the same shading correction is applied to all the frames. As a result, the technical object of obtaining parallax images suitable for stereoscopic viewing through stereographic imaging apparatus which shoots right and left parallax images.

Although the present invention has been described in considerable detail with reference to certain preferred embodiments thereof, other embodiments are possible. For example, a shading correction value for each pixel may be generated for each pixel through use of a function, or may be calculated in advance for each pixel.

The different shading correction value may be used depending on the type of the imaging optical system (e.g., optical design, lens frame design, and strictly an installation error is also considered). Furthermore, for one imaging optical system, the different shading correction value may be used depending on, F-number (the aperture size of the variable aperture), a focus position, an aperture pattern (position, size or shape) of each of the left and right shutters. Regarding the zooming, the shading correction value may change depending on a zooming position (focal length). Therefore, the DSP 16 may be configured to have the correction gain computing coefficients F used respectively for various zooming positions. In this case, the DSP 16 selects one of the correction gain computing coefficients F based on a product ID or a zooming position sent from the shooting lens 50.

The shading correction apparatus may be installed on the side of the shooting lens 50 in place of installing the shading correction apparatus on the side of the camera main body 10. The function of the shading correction apparatus may be provided as software which is executed in cooperation with hardware component in the imaging apparatus 1. Such software is installed, for example, in a personal computer. A user is able to generate parallax images, whose difference in illuminance is reduced by executing the shading correction (the software), for a moving image (or still images for left and right eyes) which is stored in a memory card and in which images for left and right eyes have been alternately recorded.

The shading correction is not limited to the above described process in which the correction gain computing coefficient F is used. For example, the shading correction may be executed using the computing coefficients which can be obtained by approximate calculation using a two-dimensional polynomial.

In the above described embodiment, the same expression is used for both of the right and left images other than the parameters x₀. However, in another embodiment, completely different expressions may be used for the left and right images so as to further reduce the difference in illuminance between parallax images.

In the above described embodiment, a common function is used for all the pixels. However, in another embodiment, different types of functions may be respectively used for a plurality of divided areas on the imaging surface 14a so as to further reduce the difference in illuminance between parallax images.

In the above described embodiment, a single imaging optical system and a liquid crystal shutter are used to alternately shoot parallax images for left and right eyes. However in another embodiment, an imaging scheme described in patent document #3 where parallax images for left and right eyes are simultaneously shot using a single imaging optical system, a pupil division minor, and, for example, a pair of left and right solid state imaging devices may be employed.

This application claims priority of Japanese Patent Application No. 2010-191699, filed on Aug. 30, 2010. The entire subject matter of the application is incorporated herein by reference.

What is claimed is:

1. A shading correction apparatus, comprising:
a reception unit which receives left and right parallax images shot through a single imaging optical system; and
a shading correction unit configured to execute different types of shading corrections respectively for the left and right parallax images so as to reduce a difference in illuminance between the left and right parallax images.

2. The shading correction apparatus according to claim 1,
wherein the shading correction unit respectively multiplies output values of pixels of the left and right parallax images by correction coefficients of two different types of distributions.

3. The shading correction apparatus according to claim 2,
wherein:
the two different types of distributions for the correction coefficients respectively corresponding to the left and right parallax images are defined such that correction coefficients of each of the left and right parallax images are arranged in accordance with a pixel arrangement of each of the left and right parallax images; and
the two different types of distributions for the correction coefficient for the left and right parallax images have an inverted relationship with respect to a line segment which divides each of the left and right parallax images into two equal parts.

4. The shading correction apparatus according to claim 2,
further comprising:
a coefficient holding unit configured to hold the correction coefficients corresponding to a type of the imaging optical system or zooming positions of the imaging optical system;
a recognition unit configured to recognize the type of the imaging optical system or the zooming positions of the imaging optical system; and
a coefficient selection unit configured to select the correction coefficients from the coefficient holding unit in accordance with a result of recognition by the recognition unit,
wherein the shading correction unit executes a shading correction using the selected correction coefficients by the coefficient selection unit.

5. A method for shading correction, comprising:
receiving left and right parallax images shot through a single imaging optical system; and
executing different types of shading corrections respectively for the left and right parallax images so as to reduce a difference in illuminance between the left and right parallax images.

6. The method according to claim 5,
wherein, in the step of executing the different types of shading corrections, output values of pixels of the left and right parallax images are multiplied respectively by correction coefficients of two different types of distributions.

7. The method according to claim 6,
wherein:
the two different types of distributions for the correction coefficients respectively corresponding to the left and right parallax images are defined such that correction coefficients of each of the left and right parallax images are arranged in accordance with a pixel arrangement of each of the left and right parallax images; and
the two different types of distributions for the correction coefficient for the left and right parallax images have an inverted relationship with respect to a line segment which divides each of the left and right parallax images into two equal parts.

8. The method according to claim 6,
further comprising:
recognizing a type of the imaging optical system or a zooming position of the imaging optical system; and
selecting correction coefficients corresponding to a recognized type of the imaging optical system or a recognized zooming position of the imaging optical system, from correction coefficients stored in a coefficient holding unit,
wherein in the executing step, a shading correction is executed using the selected correction coefficients.

9. A non-transitory computer readable medium having computer readable instruction stored thereon, which, when executed by a processor of a computer, configures the processor to perform the steps of:
receiving left and right parallax images shot through a single imaging optical system; and
executing different types of shading corrections respectively for the left and right parallax images so as to reduce a difference in illuminance between the left and right parallax images.

10. The non-transitory computer readable medium according to claim 9,
wherein, in the step of executing the different types of shading corrections, output values of pixels of the left and right parallax images are multiplied respectively by correction coefficients of two different types of distributions.

11. The non-transitory computer readable medium according to claim 10,
wherein:
the two different types of distributions for the correction coefficients respectively corresponding to the left and right parallax images are defined such that correction coefficients of each of the left and right parallax images are arranged in accordance with a pixel arrangement of each of the left and right parallax images; and
the two different types of distributions for the correction coefficient for the left and right parallax images have an inverted relationship with respect to a line segment which divides each of the left and right parallax images into two equal parts.

12. The non-transitory computer readable medium according to claim 10,
wherein the instruction is further configured to perform the steps of:
recognizing a type of the imaging optical system or a zooming position of the imaging optical system; and
selecting correction coefficients corresponding to a recognized type of the imaging optical system or a recognized zooming position of the imaging optical system, from correction coefficients stored in a coefficient holding unit,
wherein in the executing step, a shading correction is executed using the selected correction coefficients.

13. An imaging apparatus, comprising:
a pair of left and right shutters arranged to have a certain interval therebetween to sandwich an optical axis in an imaging optical system;
an open and close driving unit configured to open or close the pair of left and right shutters at a predetermined rate;
an imaging device which is driven in synchronization with the predetermined rate and on which an object image passed through each of the pair of left and right shutters is converged; and
a shading correction unit configured to execute different types of shading corrections respectively for images shot through the pair of left and right shutters so as to reduce a difference in illuminance between the images.

14. The imaging apparatus according to claim 13,
wherein the shading correction unit respectively multiplies output values of pixels of left and right parallax images by correction coefficients of two different types of distributions.

15. The imaging apparatus according to claim 14,
wherein:
the two different types of distributions for the correction coefficients respectively corresponding to the left and right parallax images are defined such that correction coefficients of each of the left and right parallax images are arranged in accordance with a pixel arrangement of each of the left and right parallax images; and
the two different types of distributions for the correction coefficient for the left and right parallax images have an inverted relationship with respect to a line segment which divides each of the left and right parallax images into two equal parts.

16. The imaging apparatus according to claim 14,
further comprising:
a coefficient holding unit configured to hold the correction coefficients corresponding to a type of the imaging optical system or zooming positions of the imaging optical system;
a recognition unit configured to recognize the type of the imaging optical system or the zooming positions of the imaging optical system; and
a coefficient selection unit configured to select the correction coefficients from the coefficient holding unit in accordance with a result of recognition by the recognition unit,
wherein the shading correction unit executes a shading correction using the selected correction coefficients by the coefficient selection unit.
